(19) United States
(12) Patent Application Publication
(10) Pub. No.: US 2026/0050375 A1
(43) Pub. Date: Feb. 19, 2026

(54) Zero-Touch Aggregate Layout Management

(71) Applicant: NetApp, Inc., San Jose, CA (US)

(72) Inventors: Suhas Girish Urkude, San Ramon, CA (US); Dean McQuinn Bangera, Holly Springs, NC (US)

(21) Appl. No.: 18/927,115

(22) Filed: Oct. 25, 2024

Related U.S. Application Data
(60) Provisional application No. 63/684,152, filed on Aug. 16, 2024.

(51) Int. Cl. G06F 3/06

(52) U.S. Cl. CPC G06F 3/0604; G06F 3/0629; G06F 3/0689

(57) ABSTRACT

The disclosure describes systems, devices, and methods for managing access to storage devices in a shared-everything data storage environment in which any controller can access each storage device of a storage aggregate. In an implementation, a method for managing the layout of the storage aggregate is provided, which may be performed by a controller. The controller receives a request to add a storage device to the data storage environment, processes the request to identify metadata associated with the storage device, including characteristics of the storage device, processes characteristics of the storage device and characteristics of redundancy groups in the storage environment to select a redundancy group for the drive, and adds the storage device to the redundancy group.

### RELATED APPLICATIONS

This application hereby claims the benefit and priority to U.S. Provisional Patent Application No. 63/684,152, titled “ZERO TOUCH AGGREGATE LAYOUT MANAGEMENT,” filed August 16, 2024, which is hereby incorporated by reference in its entirety.

### TECHNICAL FIELD

Embodiments of the present disclosure relate generally to data storage technology, and in particular, to managing layout metadata in a data storage environment.

### BACKGROUND

A typical architecture of a data storage environment includes a host device, a controller, and storage devices capable of storing data. The host device interfaces with users to receive input/output requests for accessing the storage devices, and the host device communicates the input/output requests to the controller. The controller then interfaces with the storage devices to access locations in the storage devices specified in the input/output requests. The input/output requests refer to read operations, in which the controller reads data from the storage devices, and write operations, in which the controller writes data to the storage devices.

A one-to-one architecture in data storage contexts refers to an arrangement in which each controller in a data storage environment accesses a specific subset of storage devices in the data storage environment but does not interface with nor control other subsets of storage devices. Problematically, adding or replacing controllers to increase compute power in the environment requires adding or replacing associated storage devices given the nature of the architecture. Not only does this increase the cost of upgrading or replacing existing hardware, but also this increases the time and processing capacity required to replace equipment. Furthermore, the maximum compute power and efficiency of the overall system is limited based on the capabilities and bandwidth of a controller as input/output operations are not parallelized among multiple controllers.

Other problems also exist with such architectures. For example, when a controller or associated storage device fails, the entire portion of the data storage environment may be unavailable until recovery operations are performed. To improve redundancy and recovery in one-to-one data storage architectures, each subset of storage devices can be made up of several inexpensive data disks and a parity disk that provide redundancy with respect to each other. However, these redundancy groups rely upon a single controller scheme and shared metadata, which means the storage devices of a given group still fail together when issues occur.

### SUMMARY

The technology described herein utilizes a shared-everything architecture for a data storage environment including multiple controllers and storage devices organized into redundancy groups (e.g., Redundant Array of Inexpensive Disks (RAID) groups). In this architecture, any controller can access any storage device, and further, any controller can automatically manage the addition of a storage device to the environment to ensure an optimal (e.g., best fit, e.g., most physically and/or logically similar) layout among redundancy groups in the environment without manual intervention. While generally applicable to numerous endeavors, such advantages may be especially useful in data storage environments and input/output (I/O) processing applications.

In an implementation, a method for operating a controller in a data storage environment to provide zero-touch aggregate layout management is provided. Aggregate layout management refers to the process of managing a pool (aggregate) of storage devices when a storage device is physically added to the pool in an enclosure (e.g., a shelf, a rack). Zero-touch refers to the automation thereof.

A controller in the data storage environment performs such a method when a storage device(s) (referring interchangeably to the terms storage device, disk, and drive) is added to the data storage environment. For example, the method includes identifying a request to add a storage device to a data storage aggregate (e.g., a plurality of storage devices logically coupled in a cluster and/or physically coupled in an enclosure) in the data storage environment. The method also includes processing drive characteristics and redundancy group characteristics to select a redundancy group among multiple redundancy groups for the storage device. Upon identifying the best fit redundancy group, the controller associates the storage group with the redundancy group.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter. These and other features and aspects of various examples may be understood in view of the following detailed discussion and accompanying drawings.

### BRIEF DESCRIPTION OF THE DRAWINGS

For a more complete understanding of the present invention(s), and the advantages thereof, reference is now made to the following descriptions taken in conjunction with the accompanying drawings.

FIG. 1 illustrates an example data storage system in an implementation.

FIG. 2 illustrates a method for managing groups of storage devices of a data storage system in an implementation.

FIGS. 3A, 3B, 3C, and FIG. 3D illustrate example operating environments in an implementation.

FIG. 4 illustrates an example operational scenario in an implementation.

FIG. 5 illustrates a computing system suitable for implementing the various systems, operational environments, architectures, environments, methods, processes, scenarios, sequences, and frameworks discussed below with respect to the other Figures.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

Technology is disclosed herein that mitigates the problems discussed above with respect to data recovery in existing data storage architectures by utilizing a shared-everything architecture in which each controller is capable of accessing any storage device. In a shared-everything architecture, a single pool of storage devices (referring interchangeably to the terms storage device, disk, and drive) may be utilized for an entire cluster of controllers (referring interchangeably to the terms controllers and nodes) with equal and common access to the storage devices by the controllers.

The storage devices in the data storage environment are collectively referred to as a storage aggregate. The storage aggregate is divided into multiple RAID groups (e.g., sets of drives or disks providing RAID functionality, where RAID stands for Redundant Array of Independent Disks), and each RAID group includes one or more data disks and one or more parity disks that provide redundancy with respect to each other. The arrangement of the RAID groups, and the storage devices in each RAID group, is referred to as the aggregate layout. In defining the aggregate layout, each controller in the data storage environment may be allocated a range of blocks (e.g., logical or physical address spaces) on each storage device across all the storage devices within the same RAID group (the blocks across all the storage devices being referred to as a stripe). This allows each controller to write in parallel to the same set of storage devices without corrupting each other’s data.

For an optimal and efficient layout with respect to various parameters, such as available processing capacity, available storage capacity, durability, and performance, among other parameters, each RAID group may include the same or a similar ratio of data and parity disks and/or the same or similar sized drives to prevent downsizing during creation and expansion. Maintaining the layout in accordance with such characteristics is especially important during failure or expansion of the storage aggregate to ensure storage requirements (e.g., amount of storage, storage integrity), access efficiency, and storage redundancy are not degraded.

In one-to-one data storage architectures, upon creation of RAID groups for a storage aggregate, and upon the addition of a drive to the storage aggregate, such as based on a failure or a need to increase storage capacity, a user must manually add the drive to a group of storage and associate (e.g., logically) the drive to the group and a corresponding controller. Similar issues arise in shared-everything architectures as multiple controllers may exist, each capable of communicating with all of the drives and groups thereof. However, in various embodiments, zero-touch aggregate layout management operations as disclosed herein are performed to evaluate groups of storage devices against characteristics and parameters of a newly added storage device to determine a best fit grouping for the storage device. “Zero touch” means that the process of managing the pool of storage devices may be automated such that when a new storage device is physically added to an enclosure (e.g., a shelf, a rack), the newly added storage device is automatically assigned to a RAID group. The operations occur without manual intervention thus increasing efficiency and decreasing manual effort with respect to aggregate layout management of a data storage system.

In some example embodiments, a RAID group is selected based on protection from mean time to data loss (MTTDL). A RAID group may also be selected based on other parameters. For example, the drives of each RAID group are sorted by sizes. RAID groups can be created based on combining disks of the same or similar sizes as well as based on minimum and maximum size thresholds. Based on the type and size of each drive of each RAID group, the RAID groups is managed to obtain an optimal (e.g., most efficient, best capacity) layout including when drives are added to the pool of storage, one or more of the drives of a RAID group fails, or a shelf of nodes or drives fail.

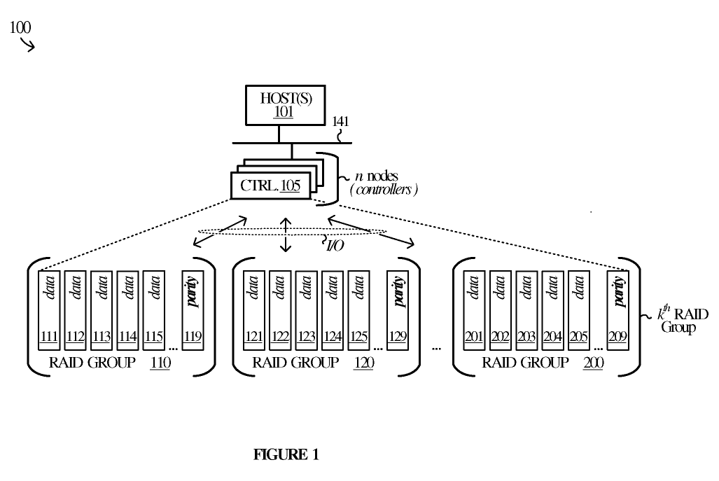

FIGS. 1, 2, 3A-3D, and FIG. 4 below illustrate and describe additional details of such systems, devices, and methods.

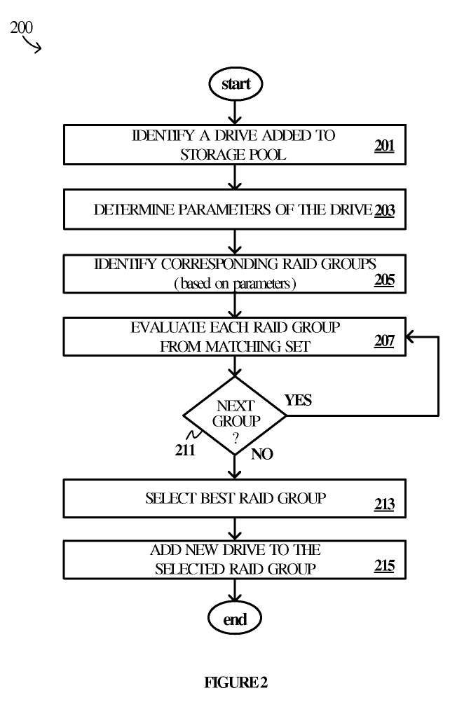

FIG. 1 illustrates system 100, which includes host(s) 101, controller 105, and Redundant Array of Inexpensive Disks (RAID) groups 110, 120, and 200. RAID groups 110, 120, and 200 may each include a plurality of storage devices, including data disks and parity disks. In various embodiments, controller 105 may be configured to perform layout management processes, such as process 200 of FIG. 2.

System 100 is representative of a data storage system operating in a data storage environment. System 100 includes multiple controllers and multiple storage devices (e.g., drives) arranged in a shared-everything architecture such that each of the controllers is capable of accessing any of the storage devices. In particular, controllers 105, 107, and 109 can perform input/output (I/O) operations (e.g., read operations, write operations) with all of the storage devices of RAID groups 110, 120, and 130.

Host(s) 101 (hereinafter referred to as host 101) is representative of one or more host servers, applications, devices, systems, or the like, capable of providing I/O operations to controllers 105, 107, and 109. Host 101 may include and may be implemented in hardware, software, and/or firmware, as well as combinations and variations thereof.

By way of example, host 101 is representative of a server running an application that interfaces with system 100 via network 103 to read from and write to the storage devices of system 100. An end user accesses host 101, or the application thereof, via a user device (e.g., a computer, a tablet, a smartphone), and provides requests to perform I/O operations via one of controllers 105, 107, or 109 to access the storage devices. In such an example, host 101 may be running a data storage administration and management application representative of data management software (e.g., NetApp ONTAP) capable of providing data management operations such as storage configuration, data protection, network setup and management, and risk and node and cluster performance monitoring, among other functions. Host 101 provides the I/O requests to controllers 105, 107, and/or 109, using an interface (e.g., a command line interface (CLI)) to the application over an application programming interface (API) (e.g., a RESTful API).

Controller 105 is representative of a control device or system that includes one or more processing devices capable of controlling, managing, and accessing each of the storage devices of system 100 as well as each of RAID groups 110, 120, and 200. Examples of the processing devices include one or more central processing units (CPUs), general purpose processors, Application Specific Integrated Circuits (ASICs), microcontroller units (MCUs), digital signal processors (DSPs), field-programmable gate arrays (FPGAs), and the like. In some examples, controller 105 represents two or more controllers coupled as a high availability (HA) pair for at least fault tolerance and back-up purposes.

Controller 105 may be running an instance of the data storage management application also running on host 101 to perform the I/O operations provided to it by host 101 via network 141. As such, controller 105 interfaces with host 101 via the application in accordance with a storage network and access protocol, such as Non-Volatile Memory Express (NVMe). Other protocols such as Network File System (NFS), Server Message Block protocol (SMB), Internet Small Computer System Interface (iSCSI), Fiber Channel (FC), Fiber Channel over Ethernet (FCoE), and the like may be contemplated. Controller 105 may further interface with the storage devices of RAID groups 110, 120, and 200 over one of the network protocols to provide I/O operations to the storage devices and receive data from the storage devices based on the I/O operations.

RAID groups 110, 120, and 200 are representative of groups of storage devices capable of providing redundancy with respect to each other. Examples of the storage devices may include flash disks and/or capacity drives, such as hard-disk drives (HDDs) and solid state drives (SSDs), as well as combinations and variations thereof. As illustrated in system 100, RAID group 110 includes data disks 111, 112, 113, 114, and 115 and parity disk 119, RAID group 120 includes data disks 121, 122, 123, 124, and 125 and parity disk 129, and RAID group 200 includes data disks 201, 202, 203, 204, and 205 and parity disk 209. The RAID groups may include additional or fewer data disks and/or parity disks. Additionally, system 100 may include additional or fewer RAID groups.

In various embodiments, each controller of system 100 (e.g., controller 105) may interface with each RAID group, as well as each data and parity disk of each RAID group, based on the shared-everything layout. In other words, controller 105 may have access to some or all of the RAID groups and data and parity disks thereof. In some such embodiments, each RAID group may be organized based on parameters of the data disks and parity disks in a pool of storage. For example, each RAID group may include data disks of the same or similar size/capacity, of the same type, and/or the like.

In operation, if a storage device is added to the pool of storage devices of system 100, controller 105 is configured to identify the addition of the storage device, determine characteristics associated with the newly added storage device and the RAID groups, select a RAID group best (e.g., most optimal, e.g., most efficient, most similar) fit for the storage device, and add the storage device to an identified RAID group. Examples of characteristics of the storage device include a size of the storage device, a processing capacity of the storage device, a storage capacity of the storage device, a type of the storage device, a durability of the storage device, a performance capability of the storage device, and the like. Similarly, examples of the characteristics of the RAID group include individual and/or average characteristics like above with respect to each storage device in the RAID group.

It may be appreciated that automatic layout management for adding storage devices to RAID groups in a storage aggregate may be applied to storage aggregates with existing RAID groups and to newly formed storage aggregates without pre-determined or existing RAID groups. As such, the operations described herein can dynamically form RAID groups among a pool of storage devices to build an optimal layout of RAID groups in a data storage environment.

An example method performable by controllers of system 100 upon the addition of a storage device in system 100 is illustrated and described in process 200 of FIG. 2.

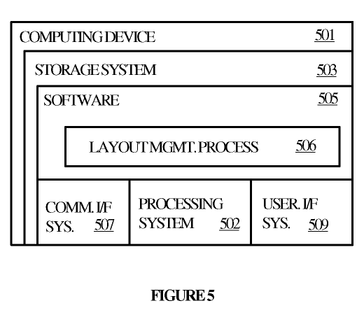

FIG. 2 illustrates process 200 for managing the layout of groups of storage devices of a data storage system. Process 200 may be employed by a computing device, such as a controller of system 100 (e.g., controller 105), an example of which is provided by computing system 501 of FIG. 5. Accordingly, process 200 may be implemented in hardware, software, and/or firmware, and may be implemented in program instructions executable by one or more processors of the computing device. The program instructions direct the computing device to operate in accordance with the steps of process 200, which reference elements of FIG. 1.

In operation 201, controller 105 identifies that a drive is added to the storage pool of storage devices of system 100. The drive may replace a failed disk, or the drive may be new, additional capacity to be added to a RAID group of system 100 to increase storage and/or compute capacity. Controller 105 identifies the addition of the drive based on a request received by controller 105 upon the physical coupling of the drive to the storage pool. More specifically, controller 105 may receive the request once the drive is physically plugged into a power supply and/or an interconnect shared among at least a group of the storage devices. In other words, the drive is plugged into an enclosure (e.g., a shelf, a rack) housing at least a group of the storage devices and outputs a signal to controller 105.

In operation 203, controller 105 determines characteristics (e.g., a size, a type, durability, performance, etc.) of the drive based on the request. In particular, upon joining the group of storage devices, the drive outputs a signal to controller 105 that includes metadata indicative of characteristics of the drive.

In operation 205, controller 105 identifies a subset of the RAID groups of system 100 based on the identified characteristics of the drive. For example, out of k RAID groups, controller 105 may identify the top-y RAID groups, where y is less than k, that have one or more characteristics in common relative to the drive. From these RAID groups, controller 105 identifies characteristics of the RAID groups, including size, performance, and durability characteristics, among other factors.

In operation 207, controller 105 evaluates the RAID groups. This entails performing a comparison between the characteristics of the drive and the characteristics of the RAID groups to identify an optimal (e.g., most efficient, most similar) fit for the newly added drive. More particularly, controller 105 compares the size of each drive in a RAID group to the size of the newly added drive, the average or median size of the drives in the RAID group to the size of the newly added drive, the type of the drives in the RAID group to the type of the newly added drive, the amount of available capacity of the drives in the RAID group to the available capacity of the newly added drive, and more. In various examples, controller 105 compares such parameters by using one or more data structures (e.g., a table) and by evaluating which characteristics match. Further, in some examples, controller 105 applies weights to some characteristics to associate a priority to the characteristics based on target layout requirements (e.g., size likeness, capacity similarity).

In operation 211, controller 105 determines whether a given group is a matching fit for the new drive or not. If controller 105 determines that a given group does not correspond to a best fit group, controller 105 moves to the next group and continues to evaluate the RAID group as in operation 207. However, if controller 105 determines that a given group corresponds to a best fit group, in operation 213, controller 105 selects the RAID group. If controller 105 determines that no existing RAID group is a best fit group, controller 105 may alternatively create a new RAID group for the new drive.

Upon selecting a best fit RAID group for the new storage device, in operation 215, controller 105 adds the new storage device to the selected RAID group and outputs an indication of the new storage device and corresponding RAID group, such as by updating metadata stored on each of the drives in association with the storage devices and corresponding RAID groups.

The above operations may be applied for any number of drives being added to a storage aggregate. For example, multiple drives may be added to the storage pool at the same time, and one or more of the controllers of system 100 may perform such operations together, in parallel, or sequentially. In some such examples, a controller may consider characteristics of the newly added drives collectively when assessing to which RAID group to add the drives, or the controller may consider characteristics of the drives individually and add the drives to one or more different RAID groups based on their individual characteristics.

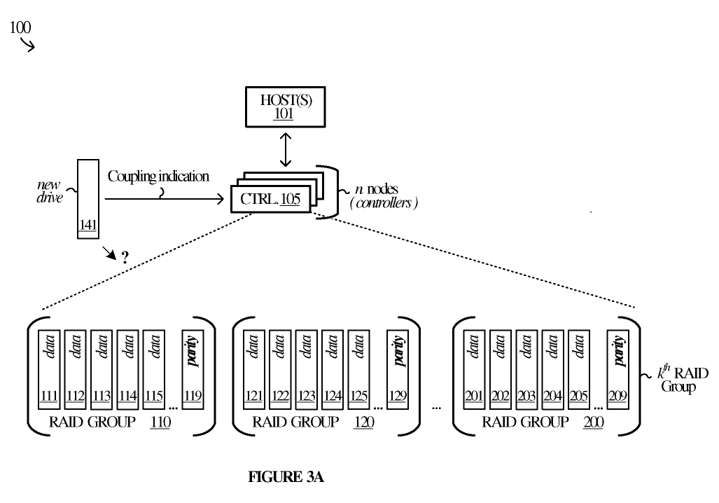

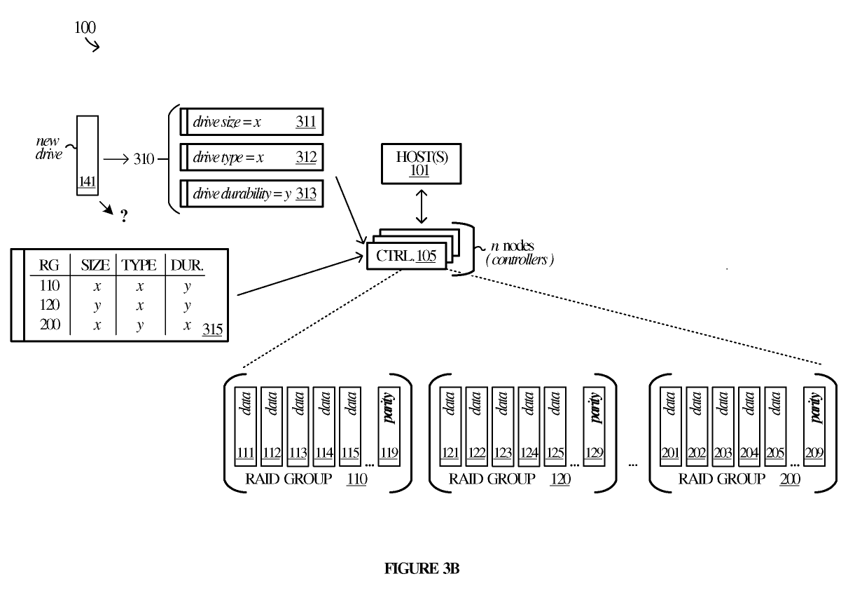

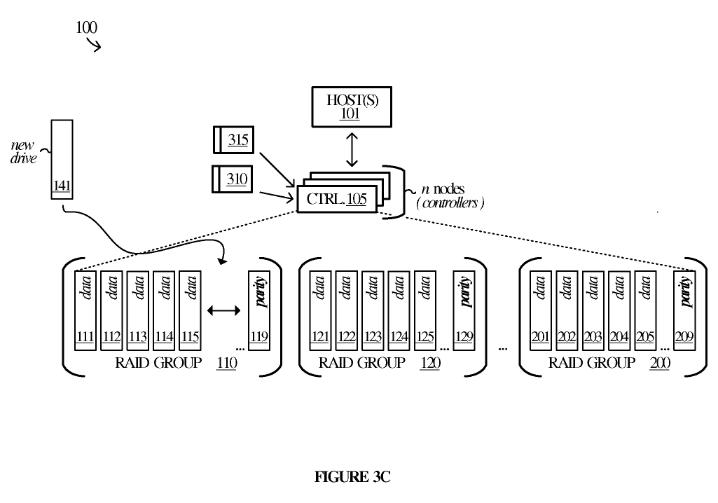

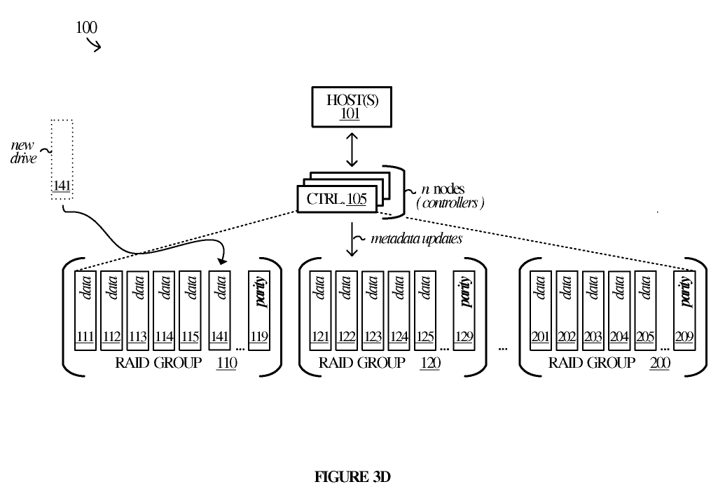

FIGS. 3A, 3B, 3C, and 3D illustrate example operating environments in which system 100 operates in an implementation. Accordingly, FIGS. 3A-3D include and reference elements of FIG. 1, such as system 100 and elements thereof. Elements of FIGS. 3A-3D are configured to perform RAID group management processes, such as process 200 of FIG. 2.

Referring first to FIG. 3A, FIG. 3A shows a first operating environment in which data disk 141 is added to system 100. The current storage pool of system 100 includes data disks 111, 112, 113, 114, 115, 121, 122, 123, 124, 125, 201, 202, 203, 204, and 205 and parity disks 119, 129, and 209. Upon being physically coupled (e.g., to a shelf holding the disks of system 100, e.g., to a power supply and/or interconnect of a shelf) and/or logically coupled (e.g., to a network of system 100) to system 100, data disk 141 outputs a coupling indication to controller 105 to request placement into a RAID group of system 100. As such, controller 105 identifies the indication and initiates a layout management process to add data disk 141 to one of the RAID groups of system 100.

FIG. 3B is illustrative of a second operating environment in which system 100 identifies characteristics of data disk 141 and of each of RAID groups 110, 120, and 200.

Controller 105 identifies the characteristics of data disk 141 based on metadata 310 included in the coupling indication received by controller 105 upon the addition of data disk 141 to system 100. In various examples, metadata 310 includes information about data disk 141, such as drive size 311, drive type 312, and drive durability 313. Metadata 310 may further include other information about data disk 141, such as the available capacity of data disk 141, the total capacity of data disk 141, the age of data disk 141, the location of data disk 141 relative to each RAID group (e.g., a shelf, a location in a shelf, etc.), and the like.

Controller 105 similarly identifies characteristics of RAID groups 110, 120, and 200 based on metadata 315 stored on disks of each RAID group. In various examples, metadata 315 includes information about each RAID group, such as the average size of drives in each RAID group, the type of drives in each RAID group, and the average durability of drives in each RAID group. Metadata 315 may further include other information about each RAID group, such as the average available capacity of drives in each RAID group, the average total capacity of drives in each RAID group, the average age of drives in each RAID group, the location of the RAID group and each drive in the RAID group, and the like. In some examples, controller 105 may also identify individual characteristics of each drive in each RAID group.

As illustrated in FIG. 3B, metadata 310 indicates that data disk 141 is associated with size x, type x, and durability y, while metadata 315 indicates that RAID group 110 is associated with size x, type x, and durability y, RAID group 120 is associated withsize y, type x, and durability y, and RAID group 200 is associated with size x, type y, and durability y.

FIG. 3C is illustrative of a third operating environment in which system 100 selects a RAID group to which to add data disk 141 based on the characteristics of data disk 141 and the RAID groups. In particular, controller 105 first selects RAID groups 110 and 200 as potential fits for data disk 141 based on comparing metadata 310 to metadata 315. Controller 105 may select a subset of the RAID groups initially based on one or more of the characteristics of data disk 141 and the RAID groups. In at least one example, controller 105 narrows the RAID groups down to a subset of RAID groups based on size. Following this example, as illustrated in FIG. 3C, data disk 141, RAID group 110, and RAID group 200 all share drive size x. As such, controller selects RAID group 110 and RAID group 200 for further evaluation.

Next, controller 105 evaluates the other characteristics of RAID groups 110 and 200 against the characteristics of data disk 141 and determines that RAID group 110 shares more characteristics with data disk 141 than RAID group 200 does as RAID group 110 shares all the same characteristics as data disk 141. In some examples, controller 105 may additionally, or instead, evaluate the characteristics based on weights assigned to each characteristic. Controller 105 may then select a RAID group based on a highest score, which may indicate a most optimal fit for data disk 141. Here, based on the evaluation between metadata 310 and metadata 315, controller 105 selects RAID group 110 as the RAID group for data disk 141.

Lastly, in FIG. 3D, controller 105 adds data disk 141 to RAID group 110. In at least one example, this entails updating layout metadata stored on each drive in system 100 to reflect the change in RAID group 110: the addition of data disk 141. Upon update to the metadata on each drive, other controllers in system 100 can identify the addition of data disk 141 to RAID group 110 and perform subsequent I/O operations using the latest layout of the storage devices. In at least another example, adding data disk 141 to RAID group 110 includes outputting an indication of the addition of data disk 141 to RAID group 110 to other controllers in system 100. Then, all of the controllers can update internally-stored metadata to perform subsequent I/O operations using the latest layout of the storage devices.

Advantageously, the process of adding a new drive or disk may occur automatically without user intervention or programming other than physically installing the new drive in a system. Additionally, this process achieves a controller-drive layout balancing capacity and performance based on automatically adding new drives to groups in a system based on matching parameters of the new drives to best-fit groups.

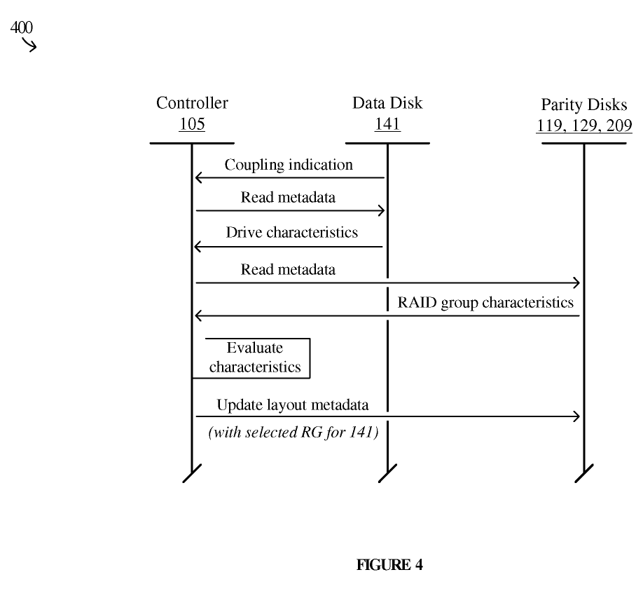

FIG. 4 illustrates operational sequence 400 demonstrative of an example sequence performed by elements of system 100, which references such elements. In particular, operational sequence 400 includes steps performed by controller 105 with respect to data disk 141 and parity disks 119, 129, and 209 of RAID groups 110, 120, and 200, respectively.

To begin operational scenario 400, controller 105 receives a coupling indication from data disk 141 requesting addition of the disk to the storage pool of storage devices of system 100. For example, controller 105 identifies the addition of the drive based on a request received by controller 105 upon the physical coupling of data disk 141 to the storage pool. More specifically, controller 105 may receive the request once data disk 141 is physically plugged into a power supply and/or an interconnect shared among at least a group of the storage devices. In other words, data disk 141 is plugged into an enclosure (e.g., a shelf, a rack) housing at least a group of the storage devices and outputs a signal to controller 105.

Next, controller 105 reads metadata from data disk 141 and from parity disks 119, 129, and 209 to determines characteristic (e.g., a size, a type, durability, performance, etc.) of data disk 141 and the disks of each RAID group. In some examples, upon joining the group of storage devices, data disk 141 outputs a signal to controller 105 that includes metadata indicative of characteristics of the drive.

Based on the metadata from data disk 141 and the RAID groups, controller 105 identifies a subset of the RAID groups of system 100. Controller 105 evaluates the RAID groups, such as by performing a comparison between the characteristics of data disk 141 and the characteristics of the RAID groups to identify an optimal (e.g., most efficient, most similar) fit for the newly added drive. More particularly, controller 105 compares the size of each drive in a RAID group to the size of the newly added drive, the average or median size of the drives in the RAID group to the size of the newly added drive, the type of the drives in the RAID group to the type of the newly added drive, the amount of available capacity of the drives in the RAID group to the available capacity of the newly added drive, and more. In various examples, controller 105 compares such parameters by using one or more data structures (e.g., a table) and by evaluating which characteristics match. Further, in some examples, controller 105 applies weights to some characteristics to associate a priority to the characteristics based on target layout requirements (e.g., size likeness, capacity similarity).

Upon identifying and selecting a best fit RAID group for data disk 141, controller 105 adds the new storage device to the selected RAID group and outputs an indication of the new storage device and corresponding RAID group, such as by updating metadata stored on each of the drives in association with the storage devices and corresponding RAID groups.

It may be appreciated that developing strategies to mitigate the impact of data loss and disruption of requests to access data and corresponding storage devices due to storage device management processes has become important for enterprises and end users. Failures of storage devices, updates or upgrades to storage devices, and/or failures of controllers with which to manage such storage devices may occur and interrupt access to data.

To mitigate the downtime and disruption introduced when performing storage device upgrades, rebuilds, replacements, and the like, enterprises may utilize various systems, methods, and devices as described herein to manage data management systems, clusters thereof, nodes thereof, and RAID groups including various storage devices (e.g., disks), as well as data and metadata thereof.

The disclosure describes systems, methods, and devices for managing storage devices and the layout thereof in a data storage environment, managing access to the storage devices, and the like in shared-everything data storage system architectures, as well as for at least: 1) finding the best RAID group for a new drive or new storage capacity based on a size of the drive and the size of the drives in the RAID group; 2) automatically detecting a new physical connection between a storage enclosure and a storage device; and 3) evaluating RAID groups based on storage device characteristics and parameters to automatically associate storage device(s) with an existing or a newly created RAID group.

Various embodiments of the present technology provide for a wide range of technical effects, advantages, and/or improvements to computing systems and components. For example, various embodiments may include one or more of the following technical effects, advantages, and/or improvements: 1) management of access to storage devices; 2) non-disruptive access to storage devices; 3) management of storage devices and RAID groups of storage devices; 4) scalable controllers and storage devices in a distributed shared-everything architecture; 5) scalable RAID group layouts; and 6) ability to protect against and reconcile updates to storage devices, and metadata thereof, from multiple controllers.

FIG. 5 illustrates computing system 501, which is representative of any system or collection of systems in which the various applications, processes, services, and scenarios disclosed herein may be implemented. Examples of computing system 501 include, but are not limited to server computers, web servers, cloud computing platforms, and data center equipment, as well as any other type of physical or virtual server machine, container, and any variation or combination thereof. (In some examples, computing system 501 may also be representative of desktop and laptop computers, tablet computers, smartphones, and the like.)

Computing system 501 may be implemented as a single apparatus, system, or device or may be implemented in a distributed manner as multiple apparatuses, systems, or devices. Computing system 501 includes, but is not limited to, processing system 502, storage system 503, software 505, communication interface system 507, and user interface system 509. Processing system 502 is operatively coupled with storage system 503, communication interface system 507, and user interface system 509.

Processing system 502 loads and executes software 505 from storage system 503. Software 505 includes and implements layout management process 506, which is representative of the processes discussed with respect to the preceding Figures. When executed by processing system 502, software 505 directs processing system 502 to operate as described herein for at least the various processes, operational scenarios, and sequences discussed in the foregoing implementations. Computing system 501 may optionally include additional devices, features, or functionality not discussed for purposes of brevity.

Referring still to FIG. 5, processing system 502 may include a microprocessor and other circuitry that retrieves and executes software 505 from storage system 503. Processing system 502 may be implemented within a single processing device but may also be distributed across multiple processing devices or sub-systems that cooperate in executing program instructions. Examples of processing system 502 include general purpose central processing units, microcontroller units, graphical processing units, application specific processors, integrated circuits, application specific integrated circuits, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 503 may be implemented as a single storage device but may also be implemented across multiple storage devices or sub-systems co-located or distributed relative to each other. Storage system 503 may comprise additional elements, such as a controller capable of communicating with processing system 502 or possibly other systems.

Software 505 (including layout management process 506) may be implemented in program instructions and among other functions may, when executed by processing system 502, direct processing system 502 to operate as described with respect to the various operational scenarios, sequences, and processes illustrated herein. For example, software 505 may include program instructions for implementing data, data storage, controller, drive, disk, and data storage management processes and procedures as described herein.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or," in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method for managing drives in a data storage environment, the method comprising:
receiving, by a controller in the data storage environment, a request to add one or more drives to the data storage environment, wherein the data storage environment comprises the drives and multiple controllers capable of communicating with all of the drives;
processing, by the controller, the request to identify metadata associated with the one or more drives, wherein the metadata includes characteristics of the one or more drives;
processing, by the controller, the characteristics of the one or more drives and characteristics of redundancy groups in the storage environment to select a redundancy group for the one or more drives; and
adding, by the controller, the one or more drives to the redundancy group.

2. The method of claim 1, wherein receiving the request to add the one or more drives to the data storage environment comprises receiving, by the controller in the data storage environment, an indication responsive to the one or more drives being physically coupled to an interface of the data storage environment, wherein the indication comprises the metadata associated with the one or more drives.

3. The method of claim 1, wherein the redundancy group comprises a subset of the drives of the data storage environment that provide redundancy with respect to each other.

4. The method of claim 3, wherein processing the characteristics of the one or more drives and the characteristics of the redundancy groups comprises performing a comparison between the characteristics of the one or more drives and respective characteristics of each of the redundancy groups to determine a best fit among the redundancy groups.

5. The method of claim 3, wherein the characteristics of the one or more drives comprise one or more size characteristics and one or more performance characteristics.

6. The method of claim 3, wherein the characteristics of the redundancy groups comprise size characteristics of each of the drives in each of the redundancy groups and performance characteristics of each of the drives in each of the redundancy groups.

7. The method of claim 3, wherein processing the characteristics of the one or more drives and the characteristics of the redundancy groups comprises performing a comparison between the characteristics of the one or more drives and respective characteristics of each of the redundancy groups and creating a new redundancy group in the storage aggregate based on the comparison.

8. The method of claim 3, wherein the redundancy groups comprise Redundant Array of Independent Disks (RAID) groups.

9. The method of claim 1, wherein the multiple controllers being capable of communicating with all of the drives comprises each of the multiple controllers being capable of providing input/output requests to all of the drives.

10. A computing apparatus comprising:
one or more computer-readable storage media; and
program instructions stored on the one or more computer-readable storage media executable by a processing device that, based on being read and executed by the processing device, direct the processing device to:
receive a request to add one or more drives to a data storage environment, wherein the data storage environment comprises multiple drives and multiple controllers capable of communicating with all of the drives;
process the request to identify metadata associated with the one or more drives, wherein the metadata includes characteristics of the one or more drives;
process the characteristics of the one or more drives and characteristics of redundancy groups in the storage environment to select a redundancy group for the one or more drives; and
add the one or more drives to the redundancy group.

11. The computing apparatus of claim 10, wherein to receive the request to add the one or more drives to the data storage environment, the program instructions direct the processing device to receive an indication responsive to the one or more drives being physically coupled to an interface of the data storage environment, wherein the indication comprises the metadata associated with the one or more drives.

12. The computing apparatus of claim 10, wherein the redundancy group comprises a subset of the drives of the data storage environment that provide redundancy with respect to each other.

13. The computing apparatus of claim 12, wherein to process the characteristics of the one or more drives and the characteristics of the redundancy groups, the program instructions direct the processing device to perform a comparison between the characteristics of the one or more drives and respective characteristics of each of the redundancy groups to determine a best fit among the redundancy groups.

14. The computing apparatus of claim 12, wherein the characteristics of the one or more drives comprise one or more size characteristics and one or more performance characteristics.

15. The computing apparatus of claim 12, wherein the characteristics of the redundancy groups comprise size characteristics of each of the drives in each of the redundancy groups and performance characteristics of each of the drives in each of the redundancy groups.

16. The computing apparatus of claim 12, wherein to process the characteristics of the one or more drives and the characteristics of the redundancy groups, the program instructions direct the processing device to perform a comparison between the characteristics of the drive and respective characteristics of each of the redundancy groups and create a new redundancy group in the storage aggregate based on the comparison.

17. One or more non-transitory computer-readable storage media having stored thereon program instructions executable by one or more processors of a data storage environment that, when executed by the one or more processors, direct the one or more processors to:
receive a request to add one or more drives to the data storage environment, wherein the data storage environment comprises multiple drives and multiple controllers capable of communicating with all of the drives;
process the request to identify metadata associated with the one or more drives, wherein the metadata includes characteristics of the one or more drives;
process the characteristics of the one or more drives and characteristics of redundancy groups in the storage environment to select a redundancy group for the one or more drives; and
add the one or more drives to the redundancy group.

18. The one or more non-transitory computer-readable storage media of claim 17, wherein the redundancy group comprises a subset of the drives of the data storage environment that provide redundancy with respect to each other.

19. The one or more non-transitory computer-readable storage media of claim 18, wherein to process the characteristics of the one or more drives and the characteristics of the redundancy groups, the program instructions direct the one or more processors to perform a comparison between the characteristics of the one or more drives and respective characteristics of each of the redundancy groups to determine a best fit among the redundancy groups, wherein:
the characteristics of the one or more drives comprise one or more size characteristics and one or more performance characteristics; and
the characteristics of the redundancy groups comprise size characteristics of each of the drives in each of the redundancy groups and performance characteristics of each of the drives in each of the redundancy groups.

20. The one or more non-transitory computer-readable storage media of claim 18, wherein to process the characteristics of the one or more drives and the characteristics of the redundancy groups, the program instructions direct the one or more processors to perform a comparison between the characteristics of the drive and respective characteristics of each of the redundancy groups and create a new redundancy group in the storage aggregate based on the comparison.
